(19) United States
(12) Patent Application Publication
(10) Pub. No.: US 2013/0049437 A1
(43) Pub. Date: Feb. 28, 2013

(54) MINING SYSTEM AND APPARATUS

(71) Applicants: Ralph E. Whitley, Huntersville, NC (US); Bill Wilkens, Stanley, NC (US); Keith Lee, Newton, NC (US); Benjamine Gary Causby, Maiden, NC (US)

(72) Inventors: Ralph E. Whitley, Huntersville, NC (US); Bill Wilkens, Stanley, NC (US); Keith Lee, Newton, NC (US); Benjamine Gary Causby, Maiden, NC (US)

(73) Assignee: VT LEEBOY, INC., Lincolnton, NC (US)

(21) Appl. No.: 13/215,483

(22) Filed: Aug. 23, 2011

(51) Int. Cl. E21C 35/20; B60D 1/04; B65G 41/00; B65G 19/10; B65G 37/00; E21C 27/00

(52) U.S. Cl. 299/64; 198/602; 198/300; 198/728; 280/514

(57) ABSTRACT

A mining system and components for conveyance of mined material. The system may include a continuous miner, a series of one or more conveyor carts, and a loader, coupled in series. The loader may include a first end to be connected to the second end of the series of carts, a feeder assembly proximate to the first end of the loader and also having a first end and a second end, and an elevator at the second end of the feeder assembly. The feeder assembly may include a plurality of spaced paddles connected to endless chains. The paddles convey mined material through a bin and to the elevator. Carts may be stackable, with leg supports of an upper cart being received on the side rails of an adjacent lower cart. Couplings include male and female connectors that couple when advanced toward each other.

### FIELD

Embodiments of a mining system and components described herein relate generally to continuous mining, and more particularly to apparatus for conveying mined material from a mine to a transport vehicle or storage.

### BACKGROUND

Continuous coal mining systems may include a continuous miner that is inserted into a mine seam, conveyor carts attached in a train behind the miner, and a loader attached to the rearward-most conveyor cart. The loader push and pull assists the carts and the self-propelled miner into the mine seam, and as the miner cuts farther into the mine seam, additional carts may be added to the train. Often, the carts and loader move the coal with endless conveyor belts, which may be subject to wear, tearing, and breakage. Coupling of the miner, the carts, and the loader to adjacent components may be done with apparatus that requires, for example, manual insertion of pins through openings or application of another such third discrete part in addition to features mounted to each of the components to be coupled. Carts may lack the ability to be easily stacked for relatively compact storage. In addition to coal, other materials that may be so mined include, but are not limited to, minerals and ore.

For the foregoing reasons, there is a need for a mining system and components that may reduce the failure of the components, are easy to connect and disconnect, and may be stored in a relatively compact manner.

### SUMMARY

In accordance with one embodiment described herein, a mining system is provided including a continuous miner, a series of one or more conveyor carts, and a loader. The continuous miner includes an end with cutting means and an end distal from the cutting means. Each cart has two ends, and the carts in the series of one or more conveyor carts, if more than one cart, are coupled end to end, with the series including a proximal end coupled to the miner distal end, and a distal end. The loader includes a proximal end coupled to the distal end of the series of one or more conveyor carts, a feeder assembly, and an elevator. The feeder assembly is proximate to the proximal end of the loader and includes a proximal end and a distal end. The elevator is at the distal end of the feeder assembly.

In accordance with another embodiment, a system for conveying mined material is provided, including a plurality of conveyor carts and a loader. Each cart has a longitudinal axis and includes a first end and a second end. The loader includes a first end and a second end, with the first end adapted to be connected to the second end of a cart. The loader also includes a feeder assembly proximate to the first end of the loader and also having a first end and a second end, and an elevator at the second end of the feeder assembly.

In accordance with another embodiment, a conveyor cart for mined material is provided. The conveyor cart includes a static bed including a first end, a second end, a pair of spaced side rails substantially parallel to the longitudinal axis and each with a top surface, and a bottom between the side rails. First and second spaced wheel assemblies are mounted to the static bed, and each wheel assembly includes an axle with a wheel at each end and a tire on each wheel. The first wheel assembly is disposed between the second wheel assembly the first end. A first leg support is mounted to the static bed between the first end and the first wheel assembly and includes a base. A second leg support is mounted to the static bed between the second end and the second wheel assembly, and also includes a base. When the conveyor cart is resting on substantially horizontal ground, the vertical distance between the top surface of the rail to the lowest point on the tire is greater than the vertical distance from the top surface of the rail to the lowest point on the bases of the leg supports. In some embodiments the side rails and leg supports are configured such that substantially identical carts may be stacked on one another, with the bases of the leg supports of an upper cart received on the top surface of the side rails of an adjacent lower cart.

In accordance with another embodiment, a loader for conveying mined material from a conveyor cart to transport or storage apparatus is provided. The loader includes a first end and a second end, with the first end adapted to be connected to the second end of the conveyor cart, a feeder assembly proximate to the first end of the loader and also having a first end and a second end, and an elevator at the second end of the feeder assembly. In some embodiments, the feeder assembly has a longitudinal axis and comprises a static conveyor bed with a bottom and spaced side walls on each side of the bottom, and movable flights proximate to the conveyor bed bottom and spaced along and perpendicular to the longitudinal axis for moving mined material to be increasingly distal from the miner. In other embodiments, the feeder assembly has a longitudinal axis and includes a frame, a pair of spaced endless chains operatively mounted to the frame and substantially parallel to the feeder assembly longitudinal axis, and a plurality of spaced paddles connected to the endless chains across the feeder assembly longitudinal axis. The feeder assembly may further include a bin connected to the frame, where the bin includes upstanding side walls and a floor, and the endless chains and paddles may always be higher than the lowest point on the floor of the bin when the feeder assembly is in position for operation.

In accordance with another embodiment, a coupling for connecting vehicles having a first end and a second end is provided. The coupling includes a first connector and a second connector. The first connector includes a body, an elongated member mounted to the body along an alignment member longitudinal axis, and a hook member pivotally mounted to the body about an axis substantially perpendicular to the alignment member longitudinal axis and defining an opening. The second connector includes a sleeve defining an opening therethrough along a sleeve opening longitudinal axis for receiving the alignment member, and a pin mounted to the sleeve, spaced from and substantially perpendicular to the sleeve opening longitudinal axis for being received in the opening of the hook member. In some embodiments at least one first connector is adapted to be mounted to the first end of each vehicle for coupling to at least one second connector that is adapted to be mounted to the second end of an adjacent vehicle. The hook member may include a free end distal from the pivotal mounting to the body, where the free end is sloped such that when the first connector is advanced toward the second connector, the free end engages the pin of the second connector, and the hook member pivots away from the alignment member until the pin is received in the opening of the hook member and the hook member pivots toward the alignment member.

### BRIEF DESCRIPTION OF THE DRAWINGS

For a more complete understanding, reference should now be had to the embodiments shown in the accompanying drawings and described below. In the drawings:

FIG. 1 is a side elevation view of an embodiment of a continuous mining system.

FIG. 2 is a top plan view of the continuous mining system of FIG. 1.

FIG. 3 is a perspective view of an embodiment of a male connector for use in the continuous mining system of FIG. 1.

FIG. 4 is a perspective view of an embodiment of a female connector for coupling with the male connector of FIG. 3.

FIG. 5 is a perspective view of the coupled male and female connectors of FIGS. 3 and 4.

FIG. 6 is a side elevation view of an embodiment of a loader of the continuous mining system of FIG. 1.

FIG. 7 is a front end elevation view of a first embodiment of the loader of FIG. 6.

FIG. 8 is a top plan view of a portion of the loader of FIG. 7.

FIG. 9 is a side elevation view of a portion of the loader of FIG. 7.

FIG. 10 is a front end elevation view of a second embodiment of the loader of FIG. 6.

FIG. 11 is a side elevation view of a portion of the loader of FIG. 6.

FIG. 12 is a top plan view of an embodiment of a conveyor cart of the continuous mining system of FIG. 1.

FIG. 13 is a side elevation view of the conveyor cart of FIG. 12.

FIG. 14 is a bottom plan view of the conveyor cart of FIG. 12.

FIG. 15 is a side elevation view of a plurality of the conveyor carts of FIG. 12 in a stacked configuration.

FIG. 16 is a perspective view of the conveyor cart of FIG. 12.

### DESCRIPTION

Embodiments now will be described more fully herein with reference to the accompanying drawings, in which some, but not all, embodiments are shown. A mining system and components may be embodied in many different forms and should not be construed as limited to the embodiments set forth herein; rather, these embodiments are provided so that this disclosure will satisfy applicable legal requirements. It will be understood that, where possible, any of the advantages, features, and/or operational aspects of any of the embodiments described and/or contemplated herein may be included in any other embodiment described and/or contemplated herein, and vice versa. It will also be understood that, where possible, any terms expressed in the singular form herein are meant to also include the plural form, and vice versa. Additionally, the terms “a” and/or “an” shall mean “one or more” herein, even though the phrase “one or more” may also be used herein. Additionally, although exemplary embodiments will be described in detail herein with respect to a continuous mining system function, detailed explanations of the functioning of all of the mining system components are deemed unnecessary for understanding by one of ordinary skill in the art.

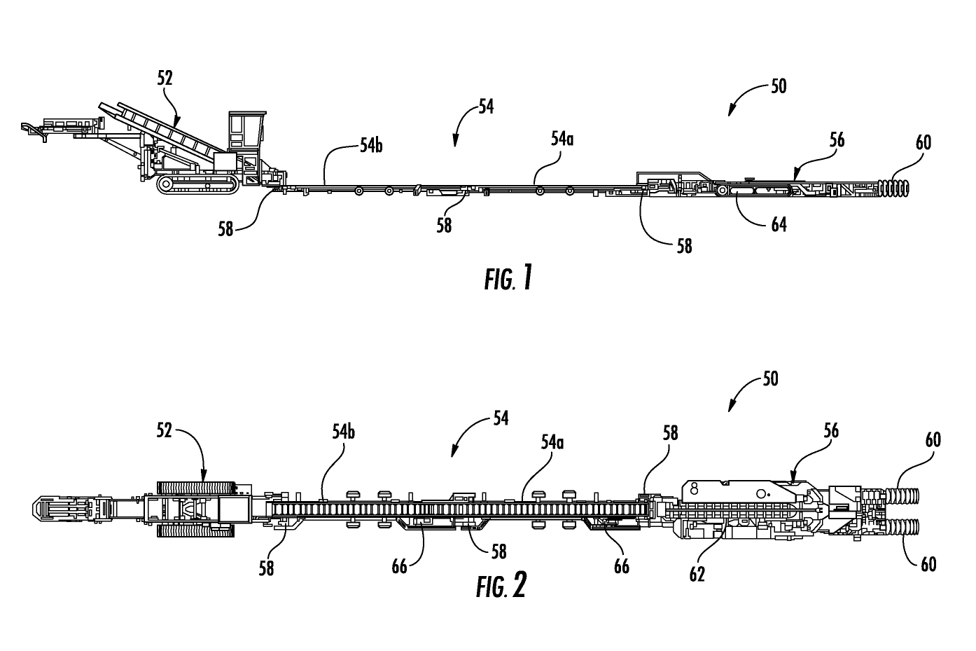

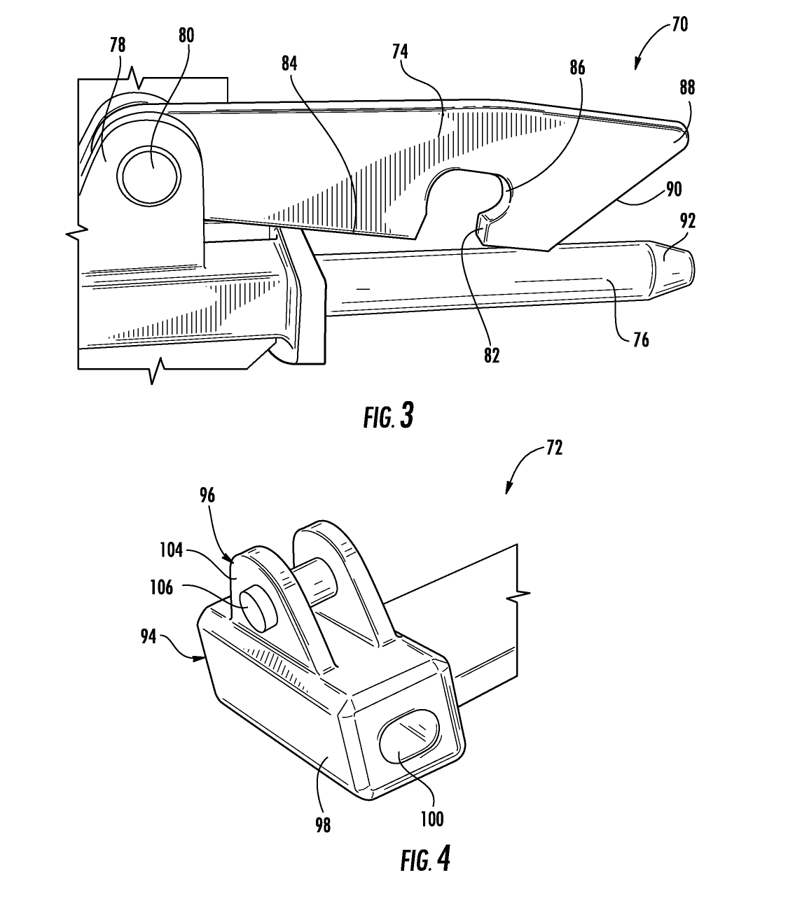

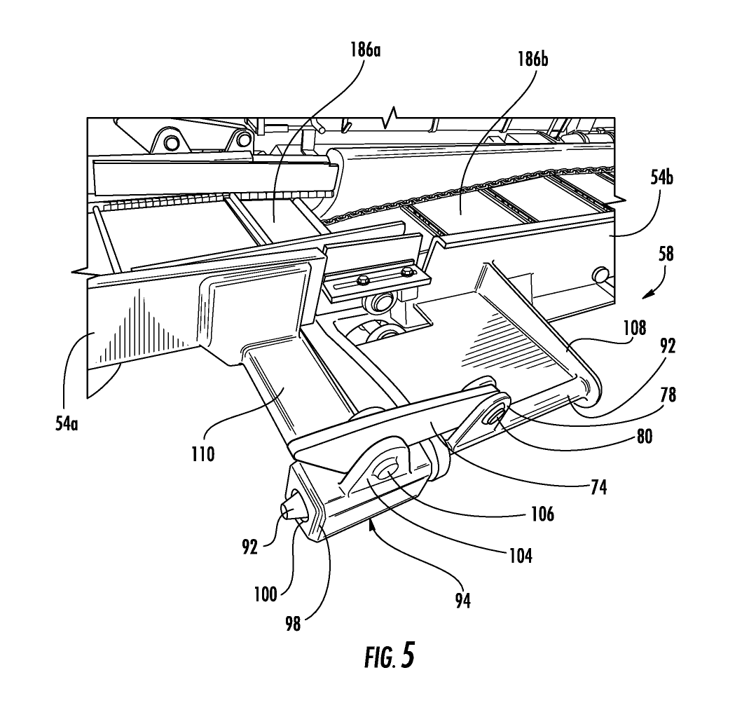

Referring now to the drawings, wherein like reference numerals designate corresponding or similar elements throughout the several views, an embodiment of a mining system for use in a continuous mining operation, such as for mining coal, is shown in FIGS. 1 and 2 and is generally designated at 50. Segments of the mining system 50 may include a self-propelled loader 52, one or more conveyor carts 54, and a continuous miner 56 for extracting coal or other mined material from a low-profile mine seam. Certain terminology is used herein for convenience only and is not to be taken as a limitation. For example, words such as “upper,” “lower,” “left,” “right,” “horizontal,” “vertical,” “upward,” and “downward” merely describe the configuration shown in the figures. The components may be oriented in any direction and the terminology, therefore, should be understood as encompassing such variations unless specified otherwise. With reference to the position of the leading end of the miner 56, where the cutting means are located, the terms “front,” “forward,” or “proximal” may refer to a position or direction along a segment relatively closer to the cutting means, and “rear,” “rearward,” or “distal” may refer to a position or direction along the segment relatively farther from the cutting means.

As shown in FIGS. 1 and 2, the continuous miner 56 is coupled to a transfer car or first conveyor cart 54a, the first conveyor cart 54a is coupled to another transfer car or second conveyor cart 54b, and the second conveyor cart 54b is coupled to the loader 52, all with couplings 58. During operation, the loader 52 is configured to push the conveyor carts 54 and miner 56 into a mine seam. As the miner 56 penetrates the wall of the mine, the miner 56 augers and then conveys the mined material rearward onto the first conveyor cart 54a. The first conveyor cart 54a then transports the mined material rearward onto the second conveyor cart 54b, and the second conveyor cart 54b then conveys the mined material rearward out of the mine and to the loader 52. When the mining operation is finished, the loader 52 assists with pulling the conveyor carts 54 and self-propelled miner 56 out of the mine seam.

The mining system 50 may be configured as a modular system, so that one or more conveyor carts 54 can be added to or subtracted from the mining system 50 at the mining site depending on the depth of penetration of the miner 52. For example, during an initial stage of the mining process, the first and second conveyor carts 54a, 54b shown in FIGS. 1 and 2 may be removed from the mining system 50 so that the loader is directly coupled to the miner 56. However, at a later stage of the mining process, as the miner 56 penetrates further into the mine seam, one or more conveyor carts 54 can be added to the mining system 50 relatively easily and quickly to extend the total length of the mining system 50. Preferably there are between two and twenty conveyor carts 54 in an operating mining system 50 at any given time. When adding or subtracting conveyor carts 54, the continuous miner 56, the loader 52, and the one or more other conveyor carts 54 already connected to the mining system 50 are all powered off.

One example of a continuous miner 56 that may be used with the mining system 50 is the Mark 22 Continuous Miner manufactured by Fairchild International. The Mark 22 is disclosed in at least U.S. Pat. No. 4,341,424 to Wilcox et al., the contents of which are incorporated by reference. The continuous miner 56 includes cutting means, such as a pair of adjustable augers 60, a conveyor 62, and a pair of tracks 64. In operation, the continuous miner 56 travels into the mine seam, uses the augers 60 to cut the wall of the mine seam, and then uses the conveyor 62 to convey mined material from the augers 60 rearward towards the conveyor cart(s) 54 and/or towards the loader 52. Specifically, the miner 56 includes a plurality of electric motors (not visible in FIGS. 1 and 2) that draw power from a 480V generator located outside of the mine seam. Those electric motors power the hydraulic subsystems on the miner 56, which include the two augers 60, the conveyor 62, and the pair of tracks 64. In addition, the electric motors on the miner 56 also transmit electric power back through the train of conveyor carts 54, such that the electric motor 66 of each conveyor cart 54 receives electric power from the electric motors on the miner 56.

The ends of segments or vehicles of the mining system 50, including the loader 52, conveyor carts 54, and miner 56 may be coupled to each other, as applicable, with couplings 58, including an embodiment as shown in FIGS. 4-6. FIG. 4 shows a male connector 70, and FIG. 5 shows a female connector 72. Each of the male connectors 70 includes a hook member 74 and an alignment member 76. The hook member 74 may be substantially flat and is pivotally connected through an opening (not visible in FIG. 4) to a clevis 78 and pin 80 at one end. An opening 82 is provided in the bottom edge 84 of the hook member 74 to create a hook, with a recessed area 86 provided to the free end 88 side of the opening 82. At the free end 88 of the hook member 74, the leading surface 90 is sloped from the bottom edge 86 upward away from the pin 80.

The alignment member 76 may be elongated and substantially rod-shaped, being substantially round in cross-section in the embodiment shown. The free end 92 tapers to a narrower diameter than the rest of the alignment member 76. The alignment member 76 may be positioned directly beneath and extending in the same direction as the hook member 74. The longitudinal axis of the alignment member 76 is substantially parallel to the longitudinal axis of the associated loader 52, cart 54, or miner 56 to which the connector 70 is mounted, and substantially perpendicular to the longitudinal axis of the pin 84.

Each of the female connectors 72 includes a sleeve portion 94 and a catch member 96. The sleeve portion 94 includes a body 98, shown as substantially rectangular in cross-section and defining an opening 100 therethrough that is substantially circular or oblong in cross-section. The catch member 96 includes a clevis 104 and a pin 106 mounted to the sleeve portion 94. The longitudinal axis of the opening 100 is substantially parallel to the longitudinal axis of the associated loader 52, cart 54, or miner 56 to which the connector 72 is mounted, and substantially perpendicular to the longitudinal axis of the pin 106.

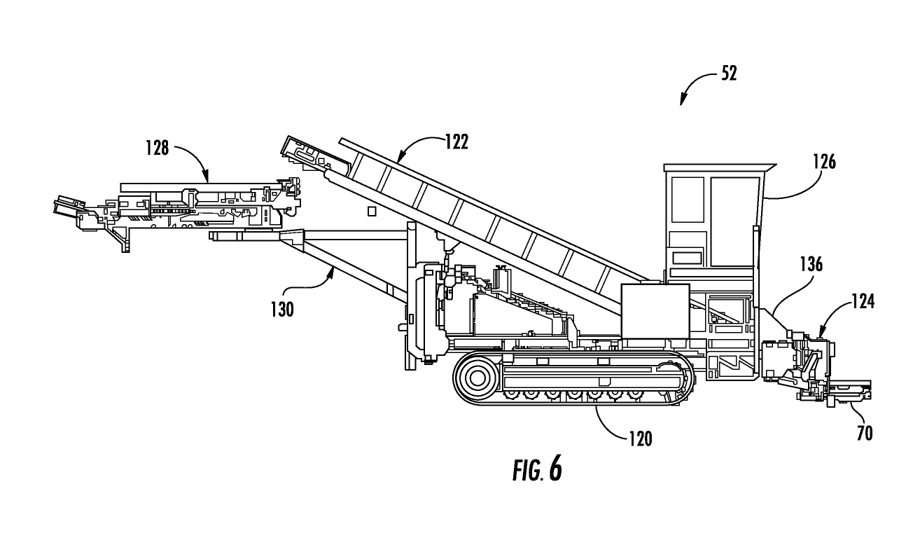

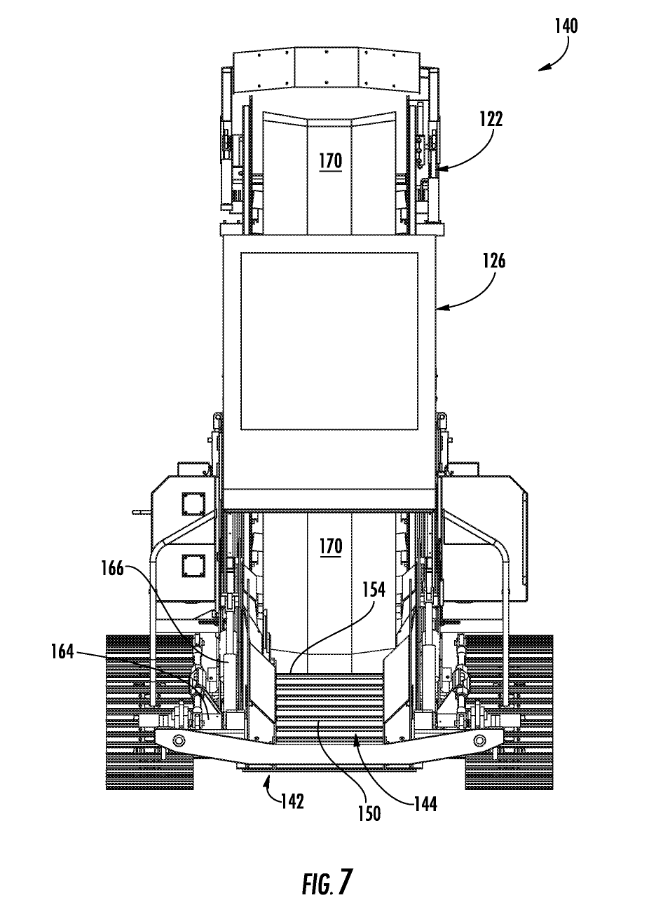

FIG. 6 shows the assembled coupling 58 mounted to conveyor carts 54a, 54b with supports 108, 110. The opening 80 in the hook member 74 of a male connector 70 is configured to receive the pin 100 of the catch member 96 of a corresponding female connector 72. Further, the sleeve portion 94 of the female connector 72 is configured to reciprocally receive the alignment member 76 of the male connector 70. To assemble the coupling 58, the male connector 70 may be advanced toward the female connector 72. The alignment member 76 first is received in the opening 102 in the sleeve portion 94, which serves to align the connectors 70, 72 and associated segments. Then the leading surface 90 of the hook member 74 engages the pin 106 of the catch member 96, which urges the hook member 74 upward until the opening 82 reaches the pin 106, and the hook member 74 drops down on the catch member 104, where the opening 82 receives the pin 106. When there is a force in a direction that would pull apart the coupled segments, the pin 106 is received in the recessed area 86 of the opening 82, which secures the connectors 70, 72 together. Once coupled, the segments can be pushed and pulled together, as one unit, by the loader 52. To decouple segments and disassemble a coupling 58, the connectors 70, 72 are pushed together such that the pin 106 is no longer in the recessed area 86, and the free end 88 of the hook member 74 is lifted to be pivoted away from the pin 106, leaving the connectors 70, 72 free to be pulled apart. In this embodiment of a coupling 58, the male connector 70 can be connected to the female connector 72 without requiring a separate locking pin or other detached member.

In the embodiment shown, the hook member 70 and devises 78, 104 are fabricated from 1-inch thick steel plate, and the alignment member 76 and pins 80, 106 are fabricated from 2-inch diameter steel bar. The steel may be, for example, steel alloy such as ASTM A36 steel. Dimensions and materials may vary as selected by one of ordinary skill in the art.

As shown in FIG. 6, the loader 52 includes a pair of tracks 120, an elevator 122, a pair of male connectors 70, a feeder assembly 124, and an operator cabin 126. In the embodiment shown, a transfer conveyor 128 with supports 130 is provided on the back of the elevator 122 to receive mined material from the elevator 122. The feeder assembly 124 is positioned in front of the elevator 122, and a pair of male connectors 70 is positioned in front of the feeder assembly 124.

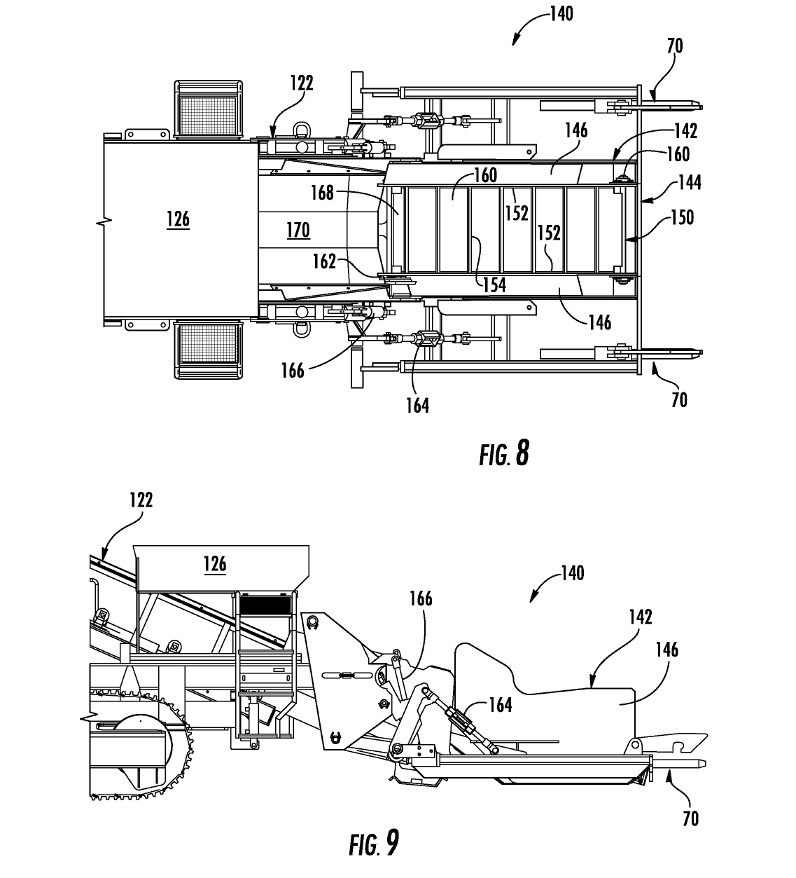

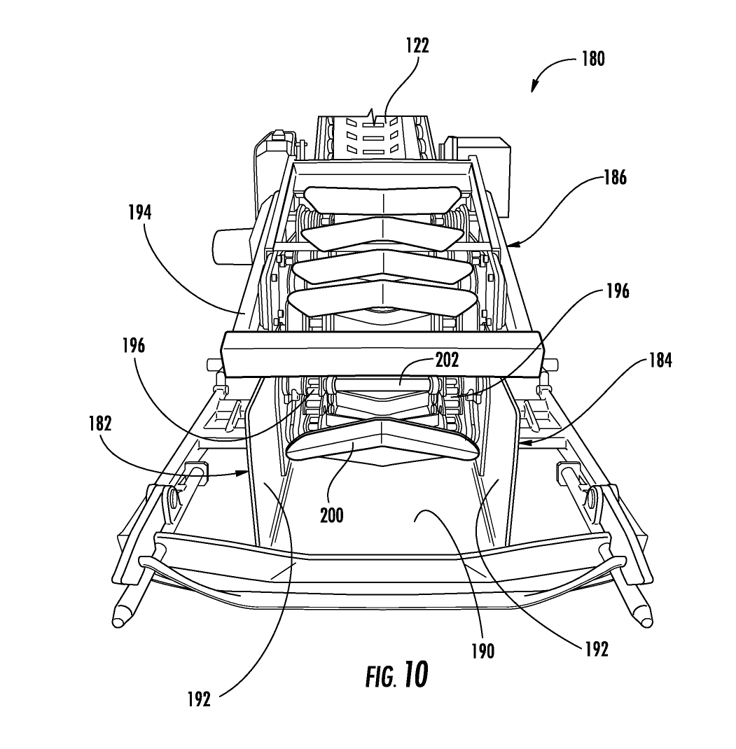

An embodiment of a loader 140 is shown in FIGS. 7-9. A feeder assembly 142 houses a feeder scraper chain conveyor assembly 144. Upstanding side walls 146 are on opposite sides of the feeder conveyor assembly 144 for containing mined material from the adjacent conveyor cart 54 (FIG. 1).

The feeder conveyor assembly 144 includes a conveyor bed 150, a pair of endless chains 152, and a plurality of flights 154. The conveyor bed 150 is defined by the pair of upstanding side walls 146 and a bottom made up of a rigid plate 160 that is mounted to and extends between the side walls 146. The rigid plate 160 is static relative to the side walls 146. The front end of the bed 150 of the feeder assembly 144 is lower than and partly beneath the rear end of the bed of the adjacent cart (not shown) to allow receiving mined material from the adjacent cart.

The chains 152 and flights 154 are both positioned in the conveyor bed 150 such that the bed 150 defines a path through which the chains 152 and flights 154 travel. The chains 152 are spaced apart from each other on opposite sides of the conveyor bed 150 with each chain 152 adjacent to a respective side wall 146, and each extends between a first shaft 160, with a sprocket proximate to each end, that is positioned near the front end of the feeder conveyor assembly 144 and a second shaft 162, also with a sprocket proximate to each end, that is positioned near the rear end. The shafts 160, 162 are oriented perpendicular to the chains 152 and the side walls 146 of the feeder conveyor assembly 144.

The flights 154 are also oriented perpendicular to the chains 152, extend between the chains 152, and are connected to the chains 152 at spaced intervals. During operation, the chains 152 and flights 154 travel through the conveyor bed 150 along the longitudinal axis of the feeder conveyor assembly 144 and revolve around the first and second shafts 160, 162 as the sprockets engage the chains so that the flights 154 push mined material from the front end of the feeder assembly 142 rearward towards the rear end. Each of the flights 154 is structured as an elongate member having an L-shaped cross-section to effectively push the mined material along the conveyor bed 150.

During operation, the feeder conveyor assembly 144 is configured to be positioned with hydraulic lifts 164, 166 with its rearward end and discharge 168 above the front end of the elevator 122. The elevator 122 may use a conveyor belt 170, which as shown may be shaped in a trough in its upper level. The mined material is transported up the elevator 122 and along the transfer conveyor 128 to separate apparatus, such as a vehicle, another conveyor, or receptacle (not shown) for transport and/or storage.

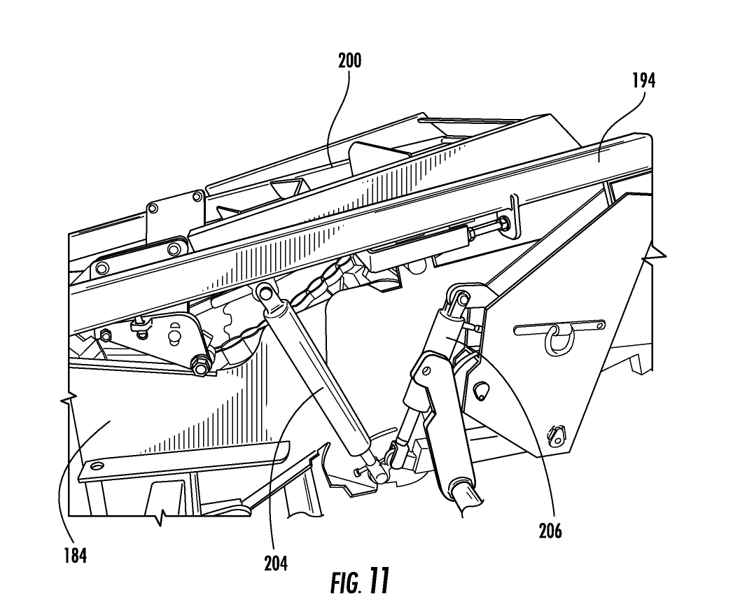

Another embodiment of a loader 180 is shown in FIGS. 10 and 11. The feeder assembly 182 in this loader 180 includes a bin 184 at the mouth of the feeder assembly 182, and a propulsion assembly 186. The bin 184 receives mined material from the adjacent conveyor cart 54 (FIG. 1). The bin 184 has a bottom surface or floor 190 and upstanding side walls 192. The propulsion assembly 186 is all higher than the floor 190 of the bin 184 and includes a frame 194 supporting a pair of endless chains 196 and a plurality of paddles 200. The endless chains 196 are spaced apart from each other, and each extends between a first shaft 202, with a sprocket proximate to each end, positioned near the mouth of the feeder assembly 182 and a second shaft (not shown), also with a sprocket proximate to each end, positioned near the elevator 122. The paddles 200 are oriented substantially perpendicular to the chains 196, extend between the chains 196, and are connected to the chains 196 at spaced intervals. The paddles 200 are formed in a substantially V-shaped configuration, with the vertex of the “V” pointing forward toward the adjacent conveyor cart 54 when the paddles are moving rearward to push mined material toward the elevator 122.

During operation, the chains 196 and paddles 200 revolve around the first shaft 202 and the second shaft above the floor of the bin 184, as the sprockets engage the chains 196 so that the paddles 200 cooperate to push mined material that enters the mouth of the feeder assembly 182 rearward towards the elevator 122. The mined material passes through the bin 184 and the upper discharge 204 of the feeder assembly 182, as shown in FIG. 11. The height of the bin 184 and upper discharge 182 is controllable with hydraulic cylinders 204, 206. The V-shaped configuration of the paddles 200 urges the mined material toward the longitudinal axis of the bin 184 and elevator 122. Thereafter, the mined material is transported up the elevator 122 and along the transfer conveyor 128 to separate apparatus, such as a vehicle, another conveyor, or receptacle (not shown) for transport and/or storage.

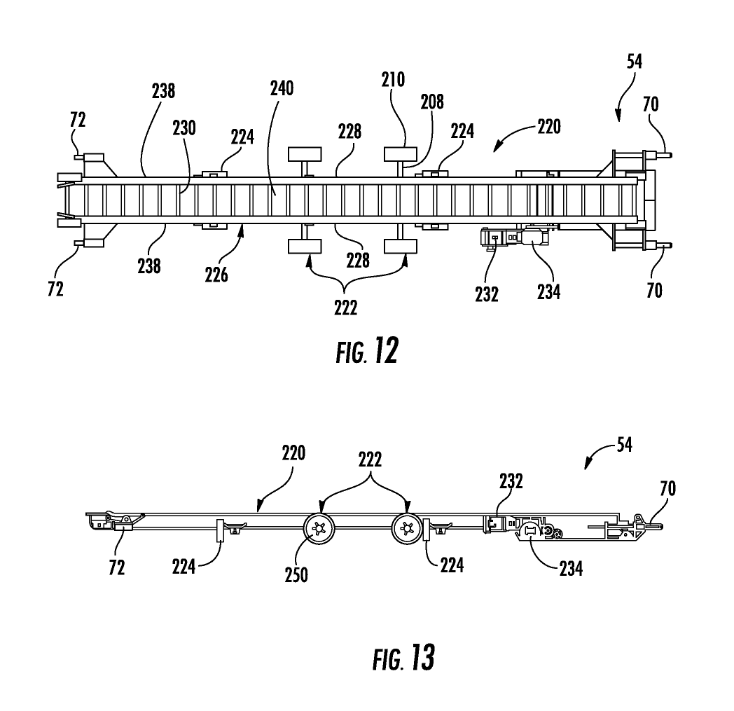

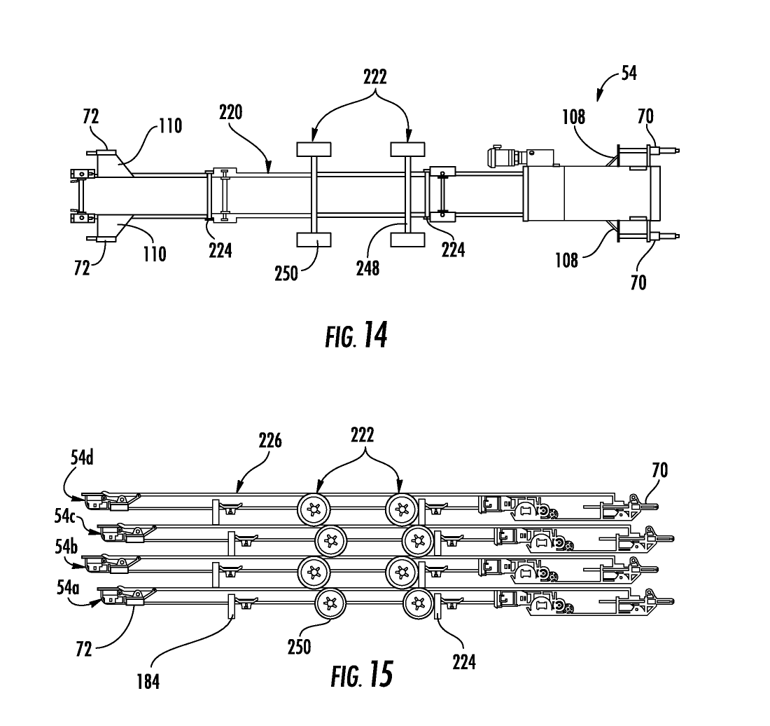

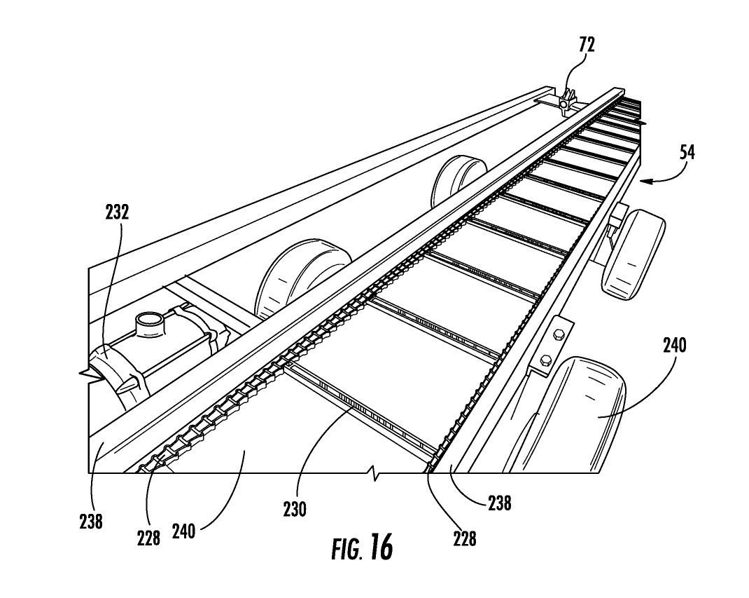

The pair of male connectors 70 on the front end of the loader 52 may mate with female connectors 72 on the rear end of either the conveyor carts 54 or the miner 56. As shown in FIGS. 12-15, the conveyor cart 54 also includes a pair of male connectors 70 at the front end of the conveyor cart 54. In addition, the continuous miner 56 includes a pair of female connectors 72 positioned behind the conveyor 62 on the miner 56. The female connectors 70 of a first conveyor cart 54a (or the miner 56) are configured to couple to corresponding male connectors 70 of a second, adjacent conveyor cart 54b (or the loader 52, as applicable).

As shown in FIGS. 12-16, embodiments of a conveyor cart 70 in the mining system 50 may include a cart scraper chain conveyor assembly 220, two wheel assemblies 222, two U-shaped support legs 224, a pair of male connectors 70, and a pair of female connectors 72.

The cart scraper chain conveyor assembly 220 of each conveyor cart 54 includes a conveyor bed 226, a pair of endless chains 228, a plurality of flights 230, an electric motor 232, and a gearbox 234. The conveyor bed 226 is static relative to the rest of the cart and is defined by a pair of vertical side rails 238 and a bottom made up of a rigid plate 240 that is mounted to and extends between the side rails 238. As shown in FIG. 5, the front end of the bed 226b of the rearward cart 54b is lower than and partly beneath the rear end of the bed 226a of the forward cart 54a to allow receiving mined material from the forward cart 54a.

Referring to FIGS. 12 and 16, the chains 228 and flights 230 are both positioned in the conveyor bed 226 such that the bed 226 defines a path through which the chains 228 and flights 230 travel. The chains 228 are spaced apart from each other on opposite sides of the conveyor bed 226 with each chain 228 adjacent to a respective side rail 238, and each extends between a first shaft (not shown), with a sprocket proximate to each end, that is positioned near the front end of the conveyor cart 54 and a second shaft (not shown), also with a sprocket proximate to each end, that is positioned near the rear end. The shafts are oriented perpendicular to the chains 228 and the side rails 238 of the conveyor cart 54.

The flights 230 are oriented perpendicular to the chains 228, extend between the chains 228, and are connected to the chains 228 at spaced intervals. During operation, the chains 228 and flights 230 travel through the conveyor bed 226 along the longitudinal axis of the conveyor cart 54 and revolve around the first and second shafts with the sprockets engaging the chains 228 so that the flights 230 push mined material from the front end of the conveyor cart 54 rearward towards the rear end. Each of the flights 230 is structured as an elongate member having an L-shaped cross-section to effectively push the mined material along the conveyor bed 226.

As shown in FIGS. 12-16, the electric motor 232 and gearbox 234 are mounted to a side rail 238 of the conveyor cart 54 near the forward end. The electric motor 232 powers the chains 228 of the conveyor cart 54 so that the chains 228 and flights 230 travel through the conveyor bed 226 and revolve around the first and second shafts. In addition to powering the chains 228 of the conveyor cart 54, the electric motor 232 is also configured to transmit electrical power to the electric motors 232 of the adjacent conveyor carts 54 via electrical connections (not shown) that extend between those conveyor carts 54. As such, the conveyor carts 54 are electrically connected to each other such that electric power can be transmitted all along the train of conveyor carts 54. A shield plate 244 that extends outboard of the conveyor bed 226 is provided underneath the forward end of the cart 54, extending rearward past the gearbox 234 for protection of the apparatus.

Each of the wheel assemblies 222 includes an axle 248 and a pair of wheels 250 including a hub and a pair of inflatable tires that fit over the hub. The wheel assemblies 250 are used to support and transport the conveyor cart 54, but the wheel assemblies 250 are not self-propelled or otherwise motorized. Instead, each of the conveyor carts 54 is pushed or pulled by the loader 52. In the embodiment shown, the axles 248 are spaced approximately 60 inches apart, and are located along the longitudinal axis of the cart 54 to be approximately evenly offset from the respective ends of the cart 54, such that the cart 54 is substantially balanced to stay horizontal when on horizontal ground and unsupported at either end.

In the embodiment shown, each of the conveyor carts 54 is approximately 21 inches tall, 65 inches wide measured to the outboard side of the wheels 250, 30 feet long, and weighs approximately 6,000 pounds. As such, each conveyor cart 54 is configured to operate in low-profile mine seams that are only twenty-four inches in height. The conveyor bed 226 may be, for example, 24 inches wide with 10 inch high rails 238, the motor 232 size may be approximately 7.5 horsepower, and the gearbox 234 rated torque may be approximately 5860 inch-lbs for a design conveyor speed (speed of the flights 190) of approximately 230 feet/minute. The distance across the conveyor cart 54 between connectors 70, 72 may be approximately 54 inches. The flights 230 may be angle iron that is 3/16-inch thick with legs having a length of 1¼ inches. The flights may be 24 inches long with approximately 11.65-inch spacing between flights. The flights may be made of ASTM A36 steel or other material selected by one of ordinary skill in the art.

The two U-shaped support legs 224 are spaced along the cart 54. The support legs 224 are mounted to the rails 238 of the conveyor bed with the legs of the “U,” when the cart 54 is resting on substantially horizontal ground, in a vertical orientation, and the base between the legs being substantially horizontal and elongated. Alternatively, the base could be in two separate parts, with one part on each leg. For a cart 54 on the ground that is not connected to an adjacent segment, the support legs 224 serve to keep the cart 54 substantially parallel to the ground if the cart 54 becomes off-balance. The carts 54 may also be stacked as shown in FIG. 12, and the support legs 224 of the upper carts 54b, 54c, 54d rest on the rails 238 of the respective lower cart 54a, 54b, 54c. The wheels 250 are outboard of the rails 238, and for upper carts 54b, 54c, 54d, the bottom of the wheels 250 are slightly lower than the top of the rails 238 of the lower cart 54a, 54b, 54c. Each cart 54a, 54b, 54c, 54d is longitudinally offset by a small amount from each adjacent cart 54a, 54b, 54c, 54d to avoid interference between the wheels 250.

Although only a few exemplary embodiments have been shown and described in considerable detail herein, it should be understood by those skilled in the art that we do not intend to be limited to such embodiments since various modifications, omissions and additions may be made to the disclosed embodiments without materially departing from the novel teachings and advantages, particularly in light of the foregoing teachings. Accordingly, we intend to cover all such modifications, omission, additions and equivalents as may be included within the spirit and scope as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A mining system comprising:
a continuous miner including an end with cutting means and an end distal from the cutting means;
a series of one or more conveyor carts, each cart with two ends and, if more than one cart, the carts being coupled end to end, the series including a proximal end coupled to the miner distal end, and a distal end; and
a loader including a proximal end coupled to the distal end of the series of one or more conveyor carts, a feeder assembly proximate to the proximal end of the loader and including a proximal end and a distal end, and an elevator at the distal end of the feeder assembly.

2. The mining system of claim 1, wherein the series of one or more conveyor carts comprises a first cart, a last cart that may be the same cart as the first cart if there is only one cart, and, optionally, intermediate carts interposed between the first and last carts, each cart including an end proximal to the cutting means and an end distal from the cutting means, wherein the proximal end of the first cart is coupled to the distal end of the miner, wherein the proximal end of any cart that is not the first cart is coupled to the distal end of an adjacent cart more proximal to the cutting means, and wherein the proximal end of the loader is coupled to the distal end of the most distal cart.

3. The mining system of claim 1, wherein each conveyor cart has a longitudinal axis and includes a static conveyor bed with a bottom and spaced side rails on each side of the bottom, and movable flights proximate to the conveyor bed bottom and spaced along and perpendicular to the longitudinal axis for moving mined material to be increasingly distal from the miner.

4. The mining system of claim 3, wherein each conveyor cart further comprises a motor operable to move the movable flights.

5. The mining system of claim 1, wherein the feeder assembly has a longitudinal axis and comprises a static conveyor bed with a bottom and spaced side walls on each side of the bottom, and movable flights proximate to the conveyor bed bottom and spaced along and perpendicular to the longitudinal axis for moving mined material to be increasingly distal from the miner.

6. The mining system of claim 1, wherein the feeder assembly has a longitudinal axis and comprises a frame, a pair of spaced endless chains operatively mounted to the frame and substantially parallel to the longitudinal axis, and a plurality of spaced paddles connected to the endless chains across the longitudinal axis.

7. The mining system of claim 6, wherein the endless chains and paddles are always higher than the lowest point on the floor of the bin when the feeder assembly is in position for operation.

8. A system for conveying mined material, the system comprising:
a plurality of conveyor carts, each cart having a longitudinal axis and including a first end and a second end; and
a loader including a first end and a second end, the first end adapted to be connected to the second end of a cart, a feeder assembly proximate to the first end of the loader and also having a first end and a second end, and an elevator at the second end of the feeder assembly.

9. The system of claim 8, further comprising a plurality of first connectors and a plurality of second connectors, with a pair of first connectors mounted to the first end of each cart and the loader for coupling to a pair of second connectors mounted to the second end of an adjacent cart.

10. The system of claim 9, wherein the first connector comprises a body, an elongated alignment member mounted to the body substantially parallel to the longitudinal axis, and a hook member pivotally mounted to the body about an axis substantially perpendicular to the longitudinal axis and defining an opening, and wherein the second connector comprises a sleeve substantially parallel to the longitudinal axis with an opening therethrough for receiving the alignment member, and a pin mounted to the sleeve above the sleeve and substantially perpendicular to the longitudinal axis for being received in the opening of the hook member.

11. The system of claim 10, wherein the hook member includes a free end distal from the pivotal mounting to the body, wherein the free end is sloped such that when the first connector is advanced toward the second connector, the free end engages the pin of the second connector, and the hook member pivots away from the alignment member until the pin is received in the opening of the hook member and the hook member pivots toward the alignment member.

12. The system of claim 8, wherein each conveyor cart comprises a conveyor bed including spaced sidewalls and a bottom therebetween, movable flights proximate to the conveyor bed bottom and spaced along and perpendicular to the longitudinal axis for moving mined material, and a motor operable to move the movable flights.

13. The system of claim 8, wherein the feeder assembly has a longitudinal axis and comprises a static conveyor bed with a bottom and spaced side walls on each side of the bottom, and movable flights proximate to the conveyor bed bottom and spaced along and perpendicular to the longitudinal axis for moving mined material to be increasingly distal from the miner.

14. The system of claim 8, wherein the feeder assembly has a longitudinal axis and comprises a frame, a pair of spaced endless chains operatively mounted to the frame and substantially parallel to the feeder assembly longitudinal axis, and a plurality of spaced paddles connected to the endless chains across the feeder assembly longitudinal axis.

15. The system of claim 14, wherein the endless chains and paddles are always higher than the lowest point on the floor of the bin when the feeder assembly is in position for operation.

16. A conveyor cart for mined material, comprising:
a static bed including a first end, a second end, a pair of spaced side rails substantially parallel to the longitudinal axis and each with a top surface, and a bottom between the side rails;
first and second spaced wheel assemblies mounted to the static bed, each wheel assembly including an axle with a wheel at each end and a tire on each wheel, wherein the first wheel assembly is disposed between the second wheel assembly the first end;
a first leg support mounted to the static bed between the first end and the first wheel assembly, the first leg support including a base; and
a second leg support mounted to the static bed between the second end and the second wheel assembly, the second leg support including a base,
wherein when the conveyor cart is resting on substantially horizontal ground, the vertical distance between the top surface of the rail to the lowest point on the tire is greater than the vertical distance from the top surface of the rail to the lowest point on the bases of the leg supports.

17. The conveyor cart of claim 16, wherein the side rails and leg supports are configured such that substantially identical carts may be stacked on one another, with the bottoms of the leg supports of an upper cart received on the top surface of the side rails of an adjacent lower cart.

18. The conveyor cart of claim 17, wherein the first and second leg support bases each include a substantially horizontal elongated member and the first and second leg supports each further comprise spaced, elongated, upstanding legs extending from the elongated member and mounted to the side rails.

19. The conveyor cart of claim 16, further comprising:
a pair of endless chains, with one endless chain proximate to each side rail and substantially parallel to the longitudinal axis;
spaced flights mounted to the endless chains substantially perpendicular to the longitudinal axis; and
a motor mounted to the static bed and operatively connected to the endless chains.

20. A loader for conveying mined material from a conveyor cart to transport or storage apparatus, the loader comprising:
a first end and a second end, the first end adapted to be connected to the second end of the conveyor cart;
a feeder assembly proximate to the first end of the loader and also having a first end and a second end; and
an elevator at the second end of the feeder assembly.

21. The loader of claim 20, wherein the feeder assembly has a longitudinal axis and comprises a static conveyor bed with a bottom and spaced side walls on each side of the bottom, and movable flights proximate to the conveyor bed bottom and spaced along and perpendicular to the longitudinal axis for moving mined material to be increasingly distal from the miner.

22. The loader of claim 21, wherein the flights comprise angle iron.

23. The loader of claim 20, wherein the feeder assembly has a longitudinal axis and comprises a frame, a pair of spaced endless chains operatively mounted to the frame and substantially parallel to the feeder assembly longitudinal axis, and a plurality of spaced paddles connected to the endless chains across the feeder assembly longitudinal axis.

24. The loader of claim 23, wherein the feeder assembly further comprises a bin connected to the frame, the bin including upstanding side walls and a floor.

25. The loader of claim 24, wherein the endless chains and paddles are always higher than the lowest point on the floor of the bin when the feeder assembly is in position for operation.

26. The loader of claim 25, wherein the paddles are configured to urge mined material distally and toward the longitudinal axis.

27. The loader of claim 26, wherein the paddles are substantially “V” shaped.

28. A coupling for connecting vehicles having a first end and a second end, the coupling comprising:
a first connector including a body, an elongated alignment member mounted to the body along an alignment member longitudinal axis, and a hook member pivotally mounted to the body about an axis substantially perpendicular to the alignment member longitudinal axis and defining an opening; and
a second connector including a sleeve defining an opening therethrough along a sleeve opening longitudinal axis for receiving the alignment member, and a pin mounted
to the sleeve and spaced from the sleeve to be substantially perpendicular to the sleeve
opening longitudinal axis for being received in the opening of the hook member, wherein the first connector is adapted to be mounted to the first end of each vehicle for coupling to the second connector that is adapted to be mounted to the second end of an adjacent vehicle.

29. The coupling of claim 28, wherein the hook member includes a free end distal from the pivotal mounting to the body, and wherein the free end is sloped such that when the first connector is advanced toward the second connector, the free end engages the pin of the second connector, and the hook member pivots away from the alignment member until the pin is received in the opening of the hook member and the hook member pivots toward the alignment member.
